(19) United States
(12) Patent Application Publication
(10) Pub. No.: US 2024/0405256 A1
(43) Pub. Date: Dec. 5, 2024

(54) Lithium Metal Secondary Battery

(71) Applicant: TOYOTA JIDOSHA KABUSHIKI KAISHA, Toyota-shi Aichi-ken (JP)

(72) Inventors: Ryuta SUGIURA, Toyota-shi Aichi-ken (JP); Tomoyuki UEZONO, Okazaki-shi Aichi-ken (JP); Takenori IKEDA, Owariasahi-shi Aichi-ken (JP); Takeshi ABE, Okazaki-shi Aichi-ken (JP); Yuki TAKAHASHI, Miyoshi-shi Aichi-ken (JP); Kenta KIMURA, Toyota-shi Aichi-ken (JP)

(73) Assignee: TOYOTA JIDOSHA KABUSHIKI KAISHA, Toyota-shi Aichi-ken (JP)

(21) Appl. No.: 18/674,132

(22) Filed: May 24, 2024

(30) Foreign Application Priority Data
May 30, 2023 (JP) 2023-088503

(51) Int. Cl. H01M 10/052; H01M 10/0587; H01M 50/107

(52) U.S. Cl. CPC H01M 10/052; H01M 10/0587; H01M 50/107

(57) ABSTRACT

A lithium metal secondary battery comprises a power generation element and an electrolyte. The power generation element includes a positive electrode and a negative electrode. The negative electrode includes a base material and raised portions. The base material is electrically conductive. The raised portions are electrically insulating. Depressed portions are formed on a surface of the base material. The raised portions are provided on a surface of the base material. The raised portions protrude outwardly from the surface of the base material. A relationship of the expression “0.001≤d/h≤10” is satisfied. d represents a depth of the depressed portions. h represents a height of the raised portions.

### CROSS REFERENCE TO RELATED APPLICATIONS

This nonprovisional application is based on Japanese Patent Application No. 2023-088503 filed on May 30, 2023, with the Japan Patent Office, the entire contents of which are hereby incorporated by reference.

### BACKGROUND OF THE DISCLOSURE

### Field

The present disclosure relates to a lithium metal secondary battery.

### Description of the Background Art

Japanese Patent Laying-Open No. 04-004563 discloses a negative electrode current collector in which a side thereof in contact with a separator has a raised shape.

### SUMMARY OF THE DISCLOSURE

Lithium metal secondary batteries (which may also be simply called “LMBs” hereinafter) have been researched. Negative electrode reactions in an LMB are Li dissolution reaction and Li deposition reaction. During charging, Li ions receive electrons at the surface of the negative electrode current collector and thereby Li is deposited. Li may form dendrites. When the dendrites grow toward the positive electrode, reversibility of negative electrode reactions may be impaired.

For example, it is suggested to provide a raised portion to a negative electrode current collector. The raised portion functions as a spacer to form space (accommodation space) around the raised portion. It is expected that Li is deposited inside the accommodation space and thereby reversibility of negative electrode reactions is improved. However, electrons can also be supplied to the raised portion to form dendrites at the tip of the raised portion. That is, there is a possibility that Li can also be deposited outside the accommodation space.

An object of the present disclosure is to improve reversibility of negative electrode reactions.

Hereinafter, the technical configuration and effects of the present disclosure will be described. It should be noted that the action mechanism includes presumption. The action mechanism does not limit the technical scope of the present disclosure.

1. A lithium metal secondary battery comprises a power generation element and an electrolyte. The power generation element includes a positive electrode and a negative electrode. The negative electrode includes a base material and raised portions. The base material is electrically conductive. The raised portions are electrically insulating. Depressed portions are formed on a surface of the base material. The raised portions are provided on a surface of the base material. The raised portions protrude outwardly from the surface of the base material. A relationship of the following expression is satisfied.

0.001≤d/h≤10

d represents a depth of the depressed portions. h represents a height of the raised portions. The depth and the height are relative to the surface of the base material.

In the LMB according to “1” above, the raised portions are electrically insulating. It is conceivable that electrons are not supplied to the raised portions. It is expected that Li is deposited on the surface of the electrically-conductive base material. On the surface of the base material, depressed portions are formed. When the base material has a large surface area, Li deposition on the surface of the base material is expected to be facilitated. Furthermore, when the depth of the depressed portions and the height of the raised portions satisfy a certain relationship, Li deposition reaction and Li dissolution reaction inside the accommodation space are expected to be facilitated. Due to the synergistic effect of the above-described actions, reversibility of negative electrode reactions is expected to be improved.

2. The LMB according to “1” above may include the following configuration, for example. The base material is porous.

With the base material being porous, uniformity of negative electrode reactions in an in-plane direction is expected to be enhanced. The base material may include a three-dimensional network structure. With the pores communicating three-dimensionally, uniformity of negative electrode reactions can be enhanced.

3. The LMB according to “1” or “2” above may include the following configuration, for example. A seed material is placed inside the depressed portions. The seed material includes at least one selected from the group consisting of Li, Mg, Al, Zn, Ag, Pt, and Au.

The seed material is expected to serve as seeds for Li nucleation. For example, the seed material may be Li. For example, the seed material may be a metal that is capable of forming an alloy with Li. With the seed material placed inside the depressed portions, reversibility of negative electrode reactions is expected to be improved.

4. The LMB according to any one of “1” to “3” above may include the following configuration, for example. At least one selected from the group consisting of a solid electrolyte and a gelled electrolyte is placed inside the depressed portions.

With at least one of a solid electrolyte and a gelled electrolyte placed inside the depressed portions, distribution of Li ions on the surface of the base material is expected to be uniform. As a result, reversibility of negative electrode reactions is expected to be improved.

5. The LMB according to any one of “1” to “4” above may include the following configuration, for example. When viewed in a plane, the raised portions extend linearly.

For example, the raised portions may be in the form of walls.

6. The LMB according to any one of “1” to “4” above may include the following configuration, for example. When viewed in a plane, the raised portions are distributed in a dot pattern.

For example, the raised portions may be in the form of columns.

7. The LMB according to any one of “1” to “6” above may include the following configuration, for example. When viewed in a cross section, the raised portion has a tapered shape or an inverted tapered shape.

With the raised portion having a tapered shape or an inverted tapered shape, reversibility of negative electrode reactions is expected to be improved.

8. The LMB according to “7” above may include the following configuration, for example. The power generation element is a wound electrode assembly. The base material has an inner circumferential surface and an outer circumferential surface. The inner circumferential surface is positioned on an inner circumferential side of the wound electrode assembly. The outer circumferential surface is a surface opposite to the inner circumferential surface. The raised portions are provided on each of the inner circumferential surface and the outer circumferential surface. The raised portion on the inner circumferential surface has a tapered shape. The raised portion on the outer circumferential surface has an inverted tapered shape.

In the case where the power generation element is a wound electrode assembly, due to a great difference between the reactivity at the inner circumferential surface of the negative electrode and the reactivity at the outer circumferential surface, for example, deterioration of performance can be facilitated. For example, when the shape of the raised portions on the inner circumferential side is different from that on the outer circumferential side, the difference of reactivity between the inner circumferential surface and the outer circumferential surface can be reduced.

9. The LMB according to “7” may include the following configuration, for example. The power generation element is a wound electrode assembly. The base material has an inner circumferential surface and an outer circumferential surface. The inner circumferential surface is positioned on an inner circumferential side of the wound electrode assembly. The outer circumferential surface is a surface opposite to the inner circumferential surface. The raised portions are provided on each of the inner circumferential surface and the outer circumferential surface. The raised portion on the inner circumferential surface has an inverted tapered shape. The raised portion on the outer circumferential surface has a tapered shape.

With the configuration that is opposite to “8” above, the difference of reactivity between the inner circumferential surface and the outer circumferential surface can be reduced.

Next, an embodiment of the present disclosure (which may also be simply called “the present embodiment” hereinafter) will be described. It should be noted that the present embodiment does not limit the technical scope of the present disclosure. The present embodiment is illustrative in any respect. The present embodiment is non-restrictive. The technical scope of the present disclosure encompasses any modifications within the meaning and the scope equivalent to the terms of the claims. For example, it is originally planned that certain configurations of the present embodiment can be optionally combined.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a conceptual view illustrating an example of an LMB according to the present embodiment.

FIG. 2 is a schematic cross-sectional view illustrating an example of a negative electrode according to the present embodiment.

FIG. 3 is a schematic plan view illustrating a first example of the planar pattern of raised portions.

FIG. 4 is a schematic plan view illustrating a second example of the planar pattern of raised portions.

FIG. 5 is a schematic cross-sectional view illustrating an example of a raised portion.

FIG. 6 is a schematic cross-sectional view illustrating a first example of the configuration of raised portions in a wound electrode assembly.

FIG. 7 is a schematic cross-sectional view illustrating a second example of the configuration of raised portions in a wound electrode assembly.

### DESCRIPTION OF THE EMBODIMENTS

### 1. Terms

Terms such as “comprise”, “include”, and “have”, and other similar terms are open-ended terms. In an open-ended term, in addition to a stated component, an additional component may or may not be further included. The term “consist of” is a closed-end term. However, in a configuration that is expressed by a closed-end term, impurities present under ordinary circumstances as well as an additional element irrelevant to the technique according to the present disclosure are encompassed. The term “consist essentially of” is a semiclosed-end term. A semiclosed-end term tolerates addition of an element that does not substantially affect the fundamental, novel features of the technique according to the present disclosure.

Expressions such as “may” and “can” are not intended to mean “must” (obligation) but rather mean “there is a possibility” (tolerance).

A singular form also includes its plural meaning, unless otherwise specified. For example, “a raised portion” may mean not only “one raised portion” but also “a plurality of raised portions”. The same applies to “a depressed portion”.

Any geometric term should not be interpreted solely in its exact meaning. Examples of geometric terms include “parallel”, “vertical”, “orthogonal”, and the like. For example, “parallel” may mean a geometric state that is deviated, to some extent, from exact “parallel”. Any geometric term herein may include tolerances and/or errors in terms of design, operation, production, and/or the like. The dimensional relationship in each figure may not necessarily coincide with the actual dimensional relationship. For the purpose of assisting understanding for the readers, the dimensional relationship in each figure may have been changed. For example, length, width, thickness, and the like may have been changed. Further, a part of a given configuration may have been omitted.

A numerical range such as “from m to n %” includes both the upper limit and the lower limit, unless otherwise specified. That is, “from m to n %” means a numerical range of “not less than m % and not more than n %”. “Not less than m % and not more than n %” includes “more than m % and less than n %”. “Not less than” and “not more than” are represented by an inequality symbol with an equality symbol, e.g., “≤”. “More than” and “less than” are represented by an inequality symbol without an equality symbol, e.g., “<”. Any numerical value selected from a certain numerical range may be used as a new upper limit or a new lower limit. For example, any numerical value from a certain numerical range may be combined with any numerical value described in another location of the present specification or in a table or a drawing to set a new numerical range.

All the numerical values are regarded as being modified by the term “about”. The term “about” may mean ±5%, ±3%, ±1%, and/or the like, for example. Each numerical value may be an approximate value that can vary depending on the implementation configuration of the technique according to the present disclosure. Each numerical value may be expressed in significant figures. Unless otherwise specified, each measured value may be the average value obtained from multiple measurements performed. The number of measurements may be 3 or more, or may be 5 or more, or may be 10 or more. Generally, the greater the number of measurements is, the more reliable the average value is expected to be. Each measured value may be rounded off based on the number of the significant figures. Each measured value may include an error occurring due to an identification limit of the measurement apparatus, for example.

Unless otherwise specified, a specific example of a measurement apparatus and the like is merely an example. A product similar to the specific example may be used.

A stoichiometric composition formula represents a typical example of a compound. A compound may have a non-stoichiometric composition. For example, “Al₂O₃” is not limited to a compound where the ratio of the amount of substance (molar ratio) is “Al/O=2/3”. “Al₂O₃” represents a compound that includes Al and O in any composition ratio, unless otherwise specified. For example, the compound may be doped with a trace element. Some of Al and/or O may be replaced by another element.

“Derivative” refers to a compound that is derived from its original compound by at least one partial modification selected from the group consisting of substituent introduction, atom replacement, oxidation, reduction, and other chemical reactions. The position of modification may be one position, or may be a plurality of positions. “Substituent” may include, for example, at least one selected from the group consisting of alkyl group, alkenyl group, alkynyl group, cycloalkyl group, unsaturated cycloalkyl group, aromatic group, heterocyclic group, halogen atom (F, Cl, Br, I, etc.), OH group, SH group, CN group, SCN group, OCN group, nitro group, alkoxy group, unsaturated alkoxy group, amino group, alkylamino group, dialkylamino group, aryloxy group, acyl group, alkoxycarbonyl group, acyloxy group, aryloxycarbonyl group, acylamino group, alkoxycarbonylamino group, aryloxy carbonylamino group, sulfonylamino group, sulfamoyl group, carbamoyl group, alkylthio group, arylthio group, sulfonyl group, sulfinyl group, ureido group, phosphoramide group, sulfo group, carboxy group, hydroxamic acid group, sulfino group, hydrazino group, imino group, silyl group, and the like. These substituents may be further substituted. When there are two or more substituents, these substituents may be the same as one another or may be different from each other. A plurality of substituents may be bonded together to form a ring. A derivative of a polymer compound (a resin material) may also be called “a modified product”.

“Copolymer” includes at least one selected from the group consisting of unspecified-type, statistical-type, random-type, alternating-type, periodic-type, block-type, and graft-type.

The expression “when viewed in a plane” refers to when a target (a negative electrode, for example) is viewed in a direction parallel to the thickness direction of the target. View in a plane corresponds to a plane view. The expression “when viewed in a cross section” refers to when a target is viewed in a direction orthogonal to the thickness direction of the target. View in a cross section corresponds to a cross-sectional view.

“The height of raised portions” and “the depth of depressed portions” are measured in a cross-sectional image of a negative electrode. The cross section is parallel to the thickness direction. For example, the cross-sectional image may be an optical micrograph. For example, the cross-sectional image may be an SEM (Scanning Electron Microscope) image. In the cross-sectional image, the surface of the base material is regarded as a reference line. The height is the distance between the highest point of the raised portions and the reference line. The depth is the distance between the lowest point of the depressed portions and the reference line. When there are a plurality of raised portions, the arithmetic mean is used. When there are ten or more raised portions, ten raised portions are randomly selected and the arithmetic mean thereof is regarded as the height of the raised portions. The same applies to the depth of the depressed portions. When the base material is porous, the pores are regarded as depressed portions. The vertical distance between the opening and the inner wall of the pore is regarded as the depth of the depressed portion.

### 2. Lithium Metal Secondary Battery

Negative electrode reactions occurring in a lithium metal secondary battery (LMB) include Li dissolution reaction and Li deposition reaction. In a typical lithium-ion secondary battery, Li deposition reaction is an unintended reaction. The LMB may have any configuration. For example, the LMB may be cylindrical, prismatic, or laminate-type. In the laminate-type, the exterior package includes a metal foil laminated film. In the present embodiment, a cylindrical LMB is described as an example.

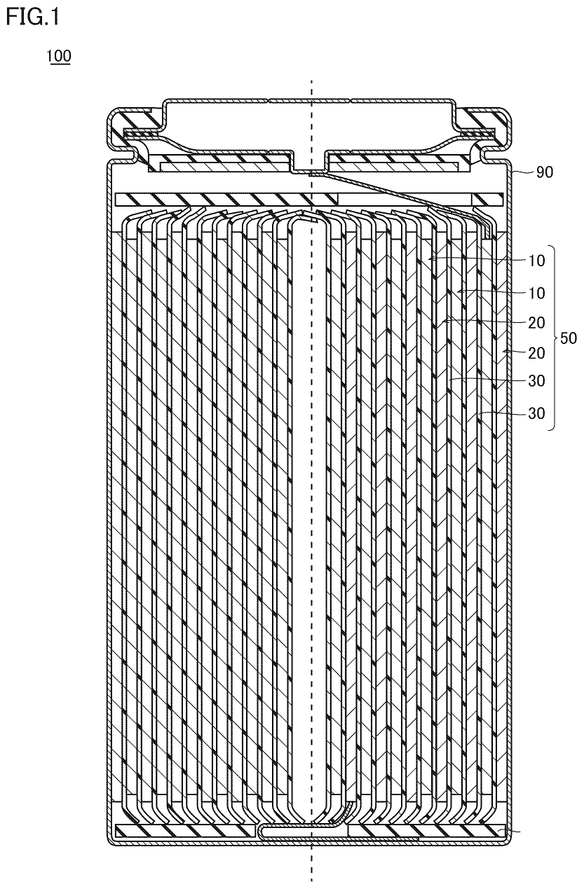

FIG. 1 is a conceptual view illustrating an example of an LMB according to the present embodiment. An LMB 100 includes a power generation element 50 and an electrolyte (not illustrated). LMB 100 may further include an exterior package 90. Exterior package 90 may accommodate power generation element 50 and the electrolyte. For example, exterior package 90 may be a cylindrical metal case.

### 3. Power Generation Element

Power generation element 50 may have any configuration. For example, power generation element 50 may include either a wound electrode assembly or a stack-type electrode assembly. The wound electrode assembly may be formed by spirally winding a belt-shaped electrode. For example, the wound electrode assembly may have a cylindrical outer shape. The wound electrode assembly may be shaped into a flat form. The stack-type electrode assembly may be formed by stacking electrodes in a thickness direction. For example, the stack-type electrode assembly may have a plate-like outer shape.

Power generation element 50 includes a positive electrode 10 and a negative electrode 20. Power generation element 50 may further include a separator 30. Separator 30 may be interposed between positive electrode 10 and negative electrode 20. Each of positive electrode 10, negative electrode 20, and separator 30 may be in sheet form.

### 4. Negative Electrode

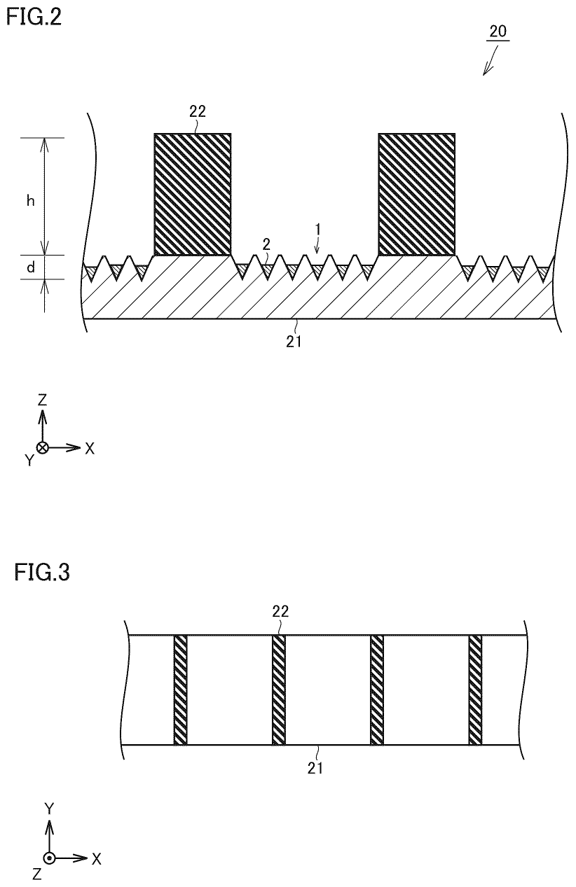

FIG. 2 is a schematic cross-sectional view illustrating an example of a negative electrode according to the present embodiment. Negative electrode 20 includes a base material 21 and raised portions 22.

### 4-1. Base Material

For example, base material 21 may be in sheet form. For example, base material 21 may be of a belt-like shape. For example, base material 21 may have a thickness from 5 to 500 μm. Base material 21 is electrically conductive. Base material 21 may function as a negative electrode current collector. For example, base material 21 may include a metal foil and/or the like. For example, base material 21 may include at least one selected from the group consisting of Cu, Ni, Fe, Zn, Pb, Ag, and Au. For example, base material 21 may include a Cu foil, a Cu alloy foil, and/or the like. For example, base material 21 may be porous. The entire base material 21 may be porous, or only a part of it may be porous. For example, a surface of base material 21 may be porous. For example, base material 21 may have a three-dimensional network structure. For example, base material 21 may include a metal porous body, a metal nonwoven fabric, a powder laminated foil, and/or the like. The powder laminated foil may be formed by sintering metal foil and metal powder. The powder laminated foil includes a foil portion and a powder portion. The powder portion is laminated on the surface of the foil portion. The powder portion is a sintered part. The powder portion is porous.

### 4-1-1. Depressed Portion

On the surface of base material 21, depressed portions 1 are formed. Depressed portions 1 may be formed all over the base material 21. Depressed portions 1 may be formed on part of the base material 21. The number density of depressed portions 1 may be greater than the number density of raised portions 22. “Number density” refers to the number per unit area. For example, when base material 21 is a metal foil, depressed portions 1 may be formed by shot peening, roughening plating, laser processing, etching, and/or the like. For example, in laser processing, a porous foil (such as a powder laminated foil, for example) may be used. For example, to a surface of a metal foil, conductive particles may be applied. The gaps between the particles may form depressed portions 1. For example, the conductive particles may include carbon particles, metal particles, and/or the like. For example, the metal particles may include a seed material, which is described below. For example, a metal porous body may be stacked on a metal foil to form depressed portions 1.

When viewed in a cross section, depressed portions 1 have a depth (d). When viewed in a plane, depressed portions 1 may be distributed in a dot pattern, for example. That is, depressed portions 1 may form pits. When viewed in a plane, depressed portions 1 may extend linearly, for example. That is, depressed portions 1 may form trenches. For example, depressed portions 1 may be evaluated in terms of the arithmetic mean height (Sa) of the surface of base material 21. For example, Sa of base material 21 may be 0.1 μm or more, or 1 μm or more, or 5 μm or more. For example, Sa of base material 21 may be 20 μm or less, or 10 μm or less, or 5 μm or less, or 1 μm or less. Sa may be measured with a surface roughness meter.

For example, the depth (d) of depressed portions 1 may be 0.1 μm or more, or 0.3 μm or more, or 0.5 μm or more, or 0.7 μm or more, or 0.9 μm or more. For example, the depth (d) of depressed portions 1 may be 1.0 μm or less, or 0.9 μm or less, or 0.7 μm or less, or 0.5 μm or less, or 0.3 μm or less.

### 4-1-2. Filling Material

The cross-sectional profile of depressed portions 1 is not particularly limited. For example, the cross-sectional profile of depressed portions 1 may be rectangular, V-shaped, U-shaped, and/or the like. When base material 21 is porous, the cross-sectional profile of depressed portions 1 may be more complex. Inside the depressed portions 1, a filling material 2 may be placed. For example, filling material 2 may cover the interior wall of depressed portions 1. Filling material 2 may fill at least part of depressed portions 1. For example, the filling factor of depressed portions 1 may be 1% or more, or 10% or more, or 30% or more, or 50% or more. For example, the filling factor of depressed portions 1 may be 100% or less, or 90% or less, or 70% or less. “Filling factor” refers to the percentage of the area occupied by filling material 2 relative to the area of depressed portions 1 in a cross-sectional image of depressed portions 1.

Filling material 2 may include any component. For example, filling material 2 may include at least one selected from the group consisting of a seed material, a solid electrolyte, and a gelled electrolyte. For example, the seed material may include at least one selected from the group consisting of Li, Mg, Al, Zn, Ag, Pt, and Au. For example, the seed material may be in film form. For example, the seed material may cover the interior wall of depressed portions 1. For example, the seed material may be in particle form. For example, the seed material may include metal nanoparticles. For example, the seed material may have a D50 from 1 nm to 20 nm.

For example, the solid electrolyte may include at least one selected from the group consisting of a sulfide solid electrolyte, an oxide solid electrolyte, a halide solid electrolyte, a hydride solid electrolyte, and a nitride solid electrolyte. For example, the sulfide solid electrolyte may include at least one selected from the group consisting of LiI—LiBr—Li₃PS₄, Li₂S—SiS₂, LiI—Li₂S—SiS₂, LiI—Li₂S—P₂S₅, LiI—Li₂O—Li₂S—P₂S₅, LiI—Li₂S—P₂O₅, LiI—Li₃PO₄—P₂S₅, Li₂S—GeS₂—P₂S₅, Li₂S—P₂S₅, Li₁₀GeP₂S₁₂, Li₄P₂S₆, Li₇P₃S₁₁, Li₃PS₄, Li₇PS₆, and Li₆PS₅X (X=Cl, Br, I). For example, “LiI—LiBr—Li₃PS₄” refers to a material that is synthesized by mixing LiI, LiBr, and Li₃PS₄ in a freely-selected molar ratio. For example, the solid electrolyte may be synthesized by a mechanochemical method. “Li₂S—P₂S₅” includes Li₃PS₄. For example, Li₃PS₄ may be produced by mixing Li₂S and P₂S₅ in “Li₂S/P₂S₅=75/25 (molar ratio)”.

For example, the halide solid electrolyte may be represented by the following formula.

Li₆₋ₙₐMₐX₆

In the above formula, n represents an oxidation number of M. For example, M may include an atom whose oxidation number is +3. For example, M may include an atom whose oxidation number is +4. M may include, for example, at least one selected from the group consisting of Y, Al, Ti, Zr, Ca, and Mg. a may satisfy the relationship of 0<a<2. X may include, for example, at least one selected from the group consisting of F, Cl, Br, and I.

For example, the halide solid electrolyte may be represented by the following formula.

Li₃₋ₐTiₐAl₁₋ₐF₆

In the above formula, a may satisfy the relationship of 0≤a≤0.1, or 0.1≤a≤0.2, or 0.2≤a≤0.3, or 0.3≤a≤0.4, or 0.4≤a≤0.5, or 0.5≤a≤0.6, or 0.6≤a≤0.7, or 0.7≤a≤0.8, or 0.8≤a≤0.9, or 0.9≤a≤1, for example.

For example, the halide solid electrolyte may be represented by the following formula.

Li₃YClₐBr_{b}I_{6-a-b}

In the above formula, the relationship of 0≤a+b≤6 is satisfied. a may satisfy the relationship of 0≤a≤1, or 1≤a≤2, or 2≤a≤3, or 3≤a≤4, or 4≤a≤5, or 5≤a≤6, for example. b may satisfy the relationship of 0≤b≤1, or 1≤b≤2, or 2≤b≤3, or 3≤b≤4, or 4≤b≤5, or 5≤b≤6, for example.

The oxide solid electrolyte may include, for example, at least one selected from the group consisting of LiNbO₃, Li_{1.5}Al_{0.5}Ge_{1.5}(PO₄)₃, La_{2/3-x}Li₃ₓTiO₃, and Li₇La₃Zr₂O₁₂. The hydride solid electrolyte may include LiBH₄ and/or the like, for example. The nitride solid electrolyte may include Li₃N, Li₃BN₂, and/or the like, for example.

The gelled electrolyte may include a liquid electrolyte and a polymer material. The polymer material may form a polymer matrix. For example, the polymer material may include at least one selected from the group consisting of polyvinylidene difluoride (PVdF), vinylidene difluoride-hexafluoropropylene copolymer (PVdF-HFP), polyacrylonitrile (PAN), polyethylene oxide (PEO), polyethylene glycol (PEG), and derivatives of these.

### 4-2. Raised Portion

Raised portions 22 are provided on the surface of base material 21. Raised portions 22 may be provided above depressed portions 1. Raised portions 22 may be provided on only one side of base material 21. Raised portions 22 may be provided on both sides of base material 21. Raised portions 22 are provided, spaced from one another, on the surface of base material 21. Raised portions 22 protrude outwardly from the surface of base material 21. The ratio of the depth (d) of depressed portions 1 to the height (h) of raised portions 22, (d/h), is from 0.001 to 10. For example, the ratio (d/h) may be 0.005 or more, or 0.01 or more, or 0.05 or more, or 0.1 or more, or 0.5 or more, or 1 or more, or 5 or more. For example, the ratio (d/h) may be 5 or less, or 1 or less, or 0.5 or less, or 0.1 or less, or 0.05 or less, or 0.01 or less, or 0.005 or less.

For example, the height (h) of raised portions 22 may be greater than the depth (d) of depressed portions 1. For example, the height (h) of raised portions 22 may be smaller than the depth (d) of depressed portions 1. For example, the height (h) of raised portions 22 may be 0.1 μm or more, or 1 μm or more, or 10 μm or more, or 30 μm or more, or 50 μm or more, or 70 μm or more, or 90 μm or more. For example, the height (h) of raised portions 22 may be 100 μm or less, or 90 μm or less, or 70 μm or less, or 50 μm or less, or 30 μm or less, or 10 μm or less, or 1 μm or less.

Raised portions 22 are electrically insulating. For example, the volume resistivity of raised portions 22 may be 1×10⁵ Ω·cm or more, or 1×10¹⁰ Ω·cm or more, or 1×10¹⁵ Ω·cm or more.

For example, raised portions 22 may include ceramic material, glass material, resin material, and/or the like. For example, raised portions 22 may include at least one selected from the group consisting of SiO₂, GeO₂, B₂O₃, P₂O₅, As₂O₅, Li₂O, Na₂O, K₂O, MgO, CaO, BaO, Al₂O₃, TiO₂, ZrO₂, polyethylene (PE), polypropylene (PP), PVdF, polytetrafluoroethylene (PTFE), polyimide (PI), polyamide (PA), and polyamide-imide (PAI).

Raised portions 22 may be formed by any method. For example, raised portions 22 may be formed by roll-to-roll transfer. For example, raised portions 22 may be formed by screen printing. For example, raised portions 22 may also be formed by photolithography, CVD (Chemical Vapor Deposition), ALD (Atomic Layer Deposition), PVD (Physical Vapor Deposition), EPD (Electrophoretic Deposition), selected dry etching, laser processing, additive manufacturing, and/or the like.

FIG. 3 is a schematic plan view illustrating a first example of the planar pattern of raised portions. For example, raised portions 22 may be in the form of walls. For example, when viewed in a plane, raised portions 22 may extend linearly. For example, raised portions 22 may extend in a straight line. For example, raised portions 22 may extend in a curved line. Between raised portions 22, space to accommodate Li may be formed. For example, the planar pattern of raised portions 22 may be a group of parallel lines. For example, the planar pattern of raised portions 22 may be in grid form. For example, when raised portions 22 are in the form of walls, the thickness of raised portions 22 may be from 1 to 1000 μm, or from 10 to 500 μm, or from 50 to 500 μm, or from 100 to 500 μm. For example, the distance between adjacent raised portions 22 may be from 1 to 1000 μm, or from 5 to 500 μm, or from 10 to 300 μm, or from 50 to 500 μm.

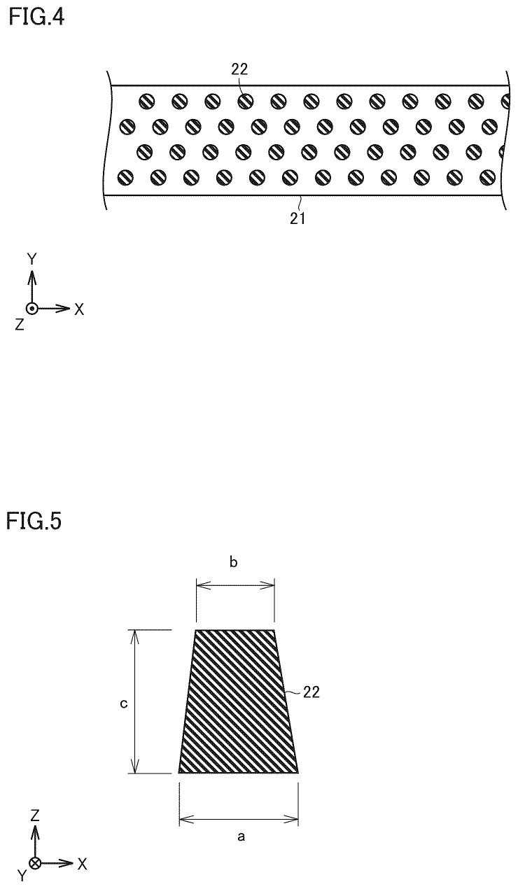

FIG. 4 is a schematic plan view illustrating a second example of the planar pattern of raised portions. For example, raised portions 22 may be in the form of columns. For example, when viewed in a plane, raised portions 22 may be distributed in a dot pattern. Around each raised portion 22, space to accommodate Li (accommodation space) may be formed. When viewed in a plane, the accommodation spaces may be in mesh form. For example, in the case where deposited Li has a network structure when viewed in a plane, reversibility of negative electrode reactions can be enhanced. Raised portions 22 are provided at any positions. Raised portions 22 may be positioned randomly. Raised portions 22 may be positioned orderly. For example, raised portions 22 may be positioned in triangle grid form, in isosceles triangle grid form, in regular triangle grid form, in rectangular grid form, in regular grid form, and/or the like. When raised portions 22 are in the form of columns, the diameter of raised portions 22 may be from 1 to 1000 μm, or from 10 to 500 μm, or from 50 to 500 μm, or from 100 to 500 μm, for example. Raised portions 22 may be cylindrical, horn-like, and/or the like, for example. When raised portions 22 are not cylindrical, the diameter of raised portions 22 refers to the largest diameter thereof. For example, the distance between adjacent raised portions 22 may be from 1 to 1000 μm, or from 5 to 500 μm, or from 10 to 300 μm, or from 50 to 500 μm. The top portion of raised portions 22 may be either flat or curved. Negative electrode 20 may include both wall-form raised portions 22 and column-form raised portions 22.

### 4-2-1. Tapered Shape

FIG. 5 is a schematic cross-sectional view illustrating an example of a raised portion. For example, raised portion 22 may have a tapered shape or an inverted tapered shape. “Tapered shape” refers to a shape of raised portion 22 that becomes narrower with the distance from base material 21. “Inverted tapered shape” refers to a shape of raised portion 22 that becomes larger with the distance from base material 21. Raised portions 22 on both sides of base material 21 may have a tapered shape. Raised portions 22 on both sides of base material 21 may have an inverted tapered shape.

Raised portion 22 as a whole may be tapered. Only a portion of raised portion 22 may be tapered. Each of the tapered shape and the inverted tapered shape may have any taper ratio. For example, the taper ratio may be 0.1 or more, or 0.2 or more, or 0.3 or more, or 0.5 or more, or 1 or more. For example, the taper ratio may be 5 or less, or 3 or less, or 2 or less, or 1 or less. The taper ratio is determined by the following equation.

$$r = ( a - b ) / c$$

r: Taper ratio
a: Largest diameter of tapered portion
b: Smallest diameter of tapered portion
c: Distance between a and b

When raised portion 22 as a whole is tapered, c may be equal to the height (h) of the raised portion 22.

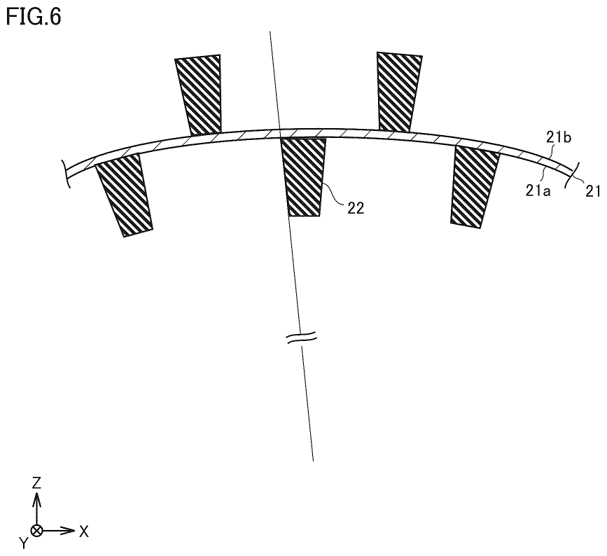

FIG. 6 is a schematic cross-sectional view illustrating a first example of the configuration of raised portions in a wound electrode assembly. In FIG. 6, a cross section vertical to the axis of winding of the wound electrode assembly is shown. In the wound electrode assembly, base material 21 has an inner circumferential surface 21a and an outer circumferential surface 21b. Inner circumferential surface 21a is positioned on the inner circumferential side. Inner circumferential surface 21a faces the axis of winding (the center). Outer circumferential surface 21b is a surface opposite to inner circumferential surface 21a. On each of inner circumferential surface 21a and outer circumferential surface 21b, raised portions 22 are provided. For example, raised portion 22 on inner circumferential surface 21a may have a tapered shape. For example, raised portion 22 on outer circumferential surface 21b may have an inverted tapered shape. On at least one of inner circumferential surface 21a and outer circumferential surface 21b, the inclination of the tapered shape may be parallel to the straight line that passes through the center of the wound electrode assembly. The angle formed by the inclination of the tapered shape and the straight line may be 30 degrees or less, or 15 degrees or less, or 10 degrees or less, or 5 degrees or less, or 1 degree or less, for example.

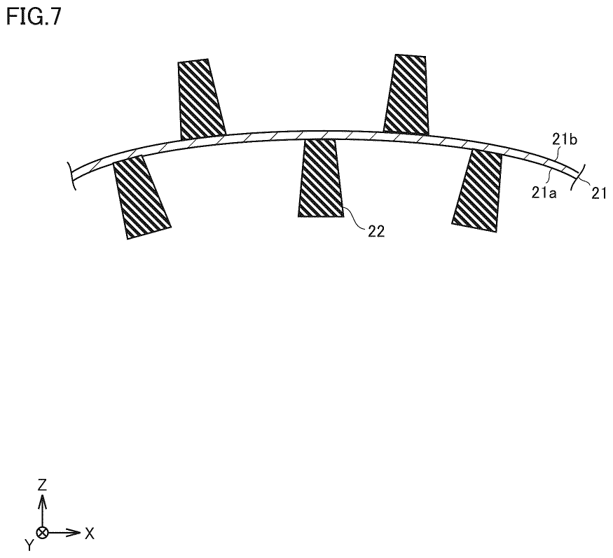

FIG. 7 is a schematic cross-sectional view illustrating a second example of the configuration of raised portions in a wound electrode assembly. For example, raised portion 22 on inner circumferential surface 21a may have an inverted tapered shape. For example, raised portion 22 on outer circumferential surface 21b may have a tapered shape.

### 5. Positive Electrode

For example, positive electrode 10 may be in sheet form. For example, positive electrode 10 may include a positive electrode current collector and a positive electrode active material layer. The positive electrode current collector is electrically conductive. The positive electrode current collector supports the positive electrode active material layer. For example, the positive electrode current collector may be in sheet form. For example, the positive electrode current collector may have a thickness from 5 to 50 μm. For example, the positive electrode current collector may include a metal foil. For example, the positive electrode current collector may include at least one selected from the group consisting of Al, Mn, Ti, Fe, and Cr. For example, the positive electrode current collector may include an Al foil, an Al alloy foil, a Ti foil, a stainless steel foil, and/or the like.

Between the positive electrode current collector and the positive electrode active material layer, an intermediate layer (not illustrated) may be provided. The intermediate layer does not include a positive electrode active material. The intermediate layer may have a thickness from 0.1 to 5 μm, for example. The intermediate layer may include a conductive material, an insulation material, a binder, and/or the like, for example. The insulation material may include alumina, boehmite, aluminum hydroxide, and/or the like, for example.

The positive electrode active material layer is placed on the surface of the positive electrode current collector. The positive electrode active material layer may be placed on only one side of the positive electrode current collector. The positive electrode active material layer may be placed on both sides of the positive electrode current collector. The positive electrode active material layer may have a thickness from 10 to 1000 μm, or from 50 to 500 μm, or from 100 to 300 μm, for example. The positive electrode active material layer includes a positive electrode active material. The positive electrode active material layer may further include a conductive material, a binder, and the like, for example.

### 5-1. Conductive Material

The conductive material may form an electron conduction path inside the positive electrode active material layer. The amount of the conductive material to be used may be, for example, from 0.1 to 10 parts by mass relative to 100 parts by mass of the positive electrode active material. The conductive material may include any component. The conductive material may include, for example, at least one selected from the group consisting of graphite, acetylene black (AB), Ketjenblack (registered trademark), vapor grown carbon fibers (VGCFs), carbon nanotubes (CNTs), and graphene flakes (GFs).

### 5-2. Binder

The binder is capable of fixing the positive electrode active material layer to the positive electrode current collector. The amount of the binder to be used may be, for example, from 0.1 to 10 parts by mass relative to 100 parts by mass of the positive electrode active material. The binder may include any component. The binder may include, for example, at least one selected from the group consisting of PVdF, PVdF-HFP, PTFE, carboxymethylcellulose (CMC), polyacrylic acid (PAA), polyvinyl alcohol (PVA), polyvinylpyrrolidone (PVP), polyoxyethylene alkyl ether, and derivatives of these.

### 5-3. Other Components

The positive electrode active material layer may further include an inorganic filler, an organic filler, a solid electrolyte, a surface modifier, a lubricant, a flame retardant, a protective agent, a flux, a coupling agent, an adsorbent, and/or the like, for example. The positive electrode active material layer may include polyoxyethylene allylphenyl ether phosphate, zeolite, a silane coupling agent, MoS₂, WO₃, and/or the like, for example.

### 5-4. Positive Electrode Active Material

The positive electrode active material may be in particle form, for example. The positive electrode active material may include any component. The positive electrode active material may include a transition metal oxide, a polyanion compound, and/or the like, for example. In a single particle (positive electrode active material), the composition may be uniform, or may be non-uniform. For example, there may be a gradient in the composition from the surface of the particle toward the center. The composition may change contiguously, or may change non-contiguously (in steps).

### 5-4-1. Transition Metal Oxide (Space Group R-3m)

The transition metal oxide may have any crystal structure. For example, the transition metal oxide may include a crystal structure that belongs to a space group R-3m and/or the like. For example, a compound represented by the general formula “LiMO₂” may have a crystal structure that belongs to a space group R-3m. The transition metal oxide may be represented by the following formula, for example.

Li₁₋ₐNiₓM₁₋ₓO₂

In the above formula, the relationships of −0.5≤a≤0.5, 0<x≤1 are satisfied.

M may include, for example, at least one selected from the group consisting of Co, Mn, and Al.

In the above formula, x may satisfy the relationship of 0<x≤0.1, 0.1≤x≤0.2, 0.2≤x≤0.3, 0.3≤x≤0.4, 0.4≤x≤0.5, 05≤x≤0.6, 0.6≤x≤0.7, 0.7≤x≤0.8, 0.8≤x≤0.9, or 0.9≤x≤1, for example, a may satisfy the relationship of −0.4≤a≤0.4, −0.3≤a≤0.3, −0.2≤a≤0.2, or −0.1≤a≤0.1, for example.

The transition metal oxide may include, for example, at least one selected from the group consisting of LiCoO₂, LiMnO₂, LiNi_{0.9}Co_{0.1}O₂, LiNi_{0.9}Mn_{0.1}O₂, and LiNiO₂.

### 5-4-1-1. NCM

The transition metal oxide may be represented by the following formula, for example. A compound represented by the following formula may also be called “NCM”.

Li₁₋ₐNiₓCo_{y}Mn_{z}O₂

In the above formula, the relationships of −0.5≤a≤0.5, 0<x<1, 0<y<1, 0<z<1, x+y+z=1 are satisfied.

In the above formula, x may satisfy the relationship of 0<x≤0.1, 0.1≤x≤0.2, 0.2≤x≤0.3, 0.3≤x≤0.4, 04≤x≤0.5, 05≤x≤0.6, 0.6≤x≤0.7, 0.7≤x≤0.8, 0.8≤x≤0.9, or 0.9≤x<1, for example.

In the above formula, y may satisfy the relationship of 0<y≤0.1, 0.1≤y≤0.2, 0.2≤y≤0.3, 0.3≤y≤0.4, 0.4≤y≤0.5, 0.5≤y≤0.6, 0.6≤y≤0.7, 0.7≤y≤0.8, 0.8≤y≤0.9, or 0.9≤y<1, for example.

In the above formula, z may satisfy the relationship of 0<z≤0.1, 0.1≤z≤0.2, 0.2≤z≤0.3, 0.3≤z≤0.4, 04≤z≤0.5, 0.5≤z≤0.6, 0.6≤z≤0.7, 0.7≤z≤0.8, 0.8≤z≤0.9, or 0.9≤z<1, for example.

NCM may include, for example, at least one selected from the group consisting of LiNi_{1/3}Co_{1/3}Mn_{1/3}O₂, LiNi_{0.4}Co_{0.3}Mn_{0.3}O₂, LiNi_{0.3}Co_{0.4}Mn_{0.3}O₂, LiNi_{0.3}Co_{0.3}Mn_{0.4}O₂, LiNi_{0.5}Co_{0.2}Mn_{0.3}O₂, LiNi_{0.5}Co_{0.3}Mn_{0.2}O₂, LiNi_{0.5}Co_{0.4}Mn_{0.1}O₂, LiNi_{0.5}Co_{0.1}Mn_{0.4}O₂, LiNi_{0.6}Co_{0.2}Mn_{0.2}O₂, LiNi_{0.6}Co_{0.3}Mn_{0.1}O₂, LiNi_{0.6}Co_{0.1}Mn_{0.3}O₂, LiNi_{0.7}Co_{0.1}Mn_{0.2}O₂, LiNi_{0.7}Co_{0.2}Mn_{0.1}O₂, LiNi_{0.5}Co_{0.1}Mn_{0.1}O₂, and LiNi_{0.9}Co_{0.05}Mn_{0.05}O₂.

### 5-4-1-2. NCA

The transition metal oxide may be represented by the following formula, for example. A compound represented by the following formula may also be called “NCA”.

Li₁₋ₐNiₓCo_{y}Al_{z}O₂

In the above formula, the relationships of −0.5≤a≤0.5, 0<x<1, 0<y<1, 0<z<1, x+y+z=1 are satisfied.

In the above formula, x may satisfy the relationship of 0<x≤0.1, 0.1≤x≤0.2, 0.2≤x≤0.3, 0.3≤x≤0.4, 04≤x≤0.5, 05≤x≤0.6, 0.6≤x≤0.7, 0.7≤x≤0.8, 0.8≤x≤0.9, or 0.9≤x<1, for example.

In the above formula, y may satisfy the relationship of 0<y≤0.1, 0.1≤y≤0.2, 0.2≤y≤0.3, 0.3≤y≤0.4, 0.4≤y≤0.5, 0.5≤y≤0.6, 0.6≤y≤0.7, 0.7≤y≤0.8, 0.8≤y≤0.9, or 0.9≤y<1, for example.

In the above formula, z may satisfy the relationship of 0<z≤0.1, 0.1≤z≤0.2, 0.2≤z≤0.3, 0.3≤z≤0.4, 04≤z≤0.5, 05≤z≤0.6, 0.6≤z≤0.7, 0.7≤z≤0.8, 0.8≤z≤0.9, or 0.9≤z<1, for example.

NCA may include, for example, at least one selected from the group consisting of LiNi_{0.7}Co_{0.1}Al_{0.2}O₂, LiNi_{0.7}Co_{0.2}Al_{0.1}O₂, LiNi_{0.8}Co_{0.1}Al_{0.1}O₂, LiNi_{0.8}Co_{0.17}Al_{0.03}O₂, LiNi_{0.8}Co_{0.15}Al_{0.05}O₂, and LiNi_{0.9}Co_{0.05}Al_{0.05}O₂.

### 5-4-1-3. Multi-Component System

The positive electrode active material may include two or more NCMs and/or the like, for example. The positive electrode active material may include NCM (0.6≤x) and NCM (x<0.6), for example. “NCM (0.6≤x)” refers to a compound in which x (Ni ratio) in the general formula “Li₁₋ₐNiₓCo_{y}Mn_{z}O₂” is 0.6 or more. NCM (0.6≤x) may also be called “a high-nickel material”, for example. NCM (0.6≤x) includes LiNi_{0.8}Co_{0.1}Mn_{0.1}O₂ and/or the like, for example. “NCM (x<0.6)” refers to a compound in which x (Ni ratio) in the general formula “Li₁₋ₐNiₓCo_{y}Mn_{z}O₂” is less than 0.6. NCM (x<0.6) includes LiNi_{1/3}Co_{1/3}Mn_{1/3}O₂ and/or the like, for example. The mixing ratio (mass ratio) between NCM (0.6≤x) and NCM (x<0.6) may be “NCM (0.6≤x)/NCM (x<0.6)=9/1 to 1/9”, or “NCM (0.6≤x)/NCM (x<0.6)=9/1 to 4/6”, or “NCM (0.6≤x)/NCM (x<0.6)=9/1 to 3/7”, for example.

The positive electrode active material may include both NCA and NCM, for example. The mixing ratio (mass ratio) between NCA and NCM may be “NCA/NCM=9/1 to 1/9”, “NCA/NCM=9/1 to 4/6”, or “NCA/NCM=9/1 to 3/7”, for example. Between NCA and NCM, the Ni ratio may be the same or may be different. The Ni ratio of NCA may be more than the Ni ratio of NCM. The Ni ratio of NCA may be less than the Ni ratio of NCM.

### 5-4-2. Transition Metal Oxide (Space Group C2/m)

The transition metal oxide may include a crystal structure that belongs to a space group C2/m and/or the like, for example. The transition metal oxide may be represented by the following formula, for example.

Li₂MO₃

In the above formula, M may include, for example, at least one selected from the group consisting of Ni, Co, Mn, and Fe.

The positive electrode active material may include a mixture of LiMO₂ (space group R-3m) and Li₂MO₃ (space group C2/m), for example. The positive electrode active material may include a solid solution that is formed of LiMO₂ and Li₂MO₃ (Li₂MO₃-LiMO₂), and/or the like, for example.

### 5-4-3. Transition Metal Oxide (Space Group Fd-3m)

The transition metal oxide may include a crystal structure that belongs to a space group Fd-3m, and/or the like, for example. The transition metal oxide may be represented by the following formula, for example.

LiMn₂₋ₓMₓO₄

In the above formula, the relationship of 0≤x≤2 is satisfied. M may include, for example, at least one selected from the group consisting of Ni, Fe, and Zn.

LiM₂O₄ (space group Fd-3m) may include, for example, at least one selected from the group consisting of LiMn₂O₄ and LiMn_{1.5}Ni_{0.5}O₄. The positive electrode active material may include a mixture of LiMO₂ (space group R-3m) and LiM₂O₄ (space group Fd-3m), for example. The mixing ratio (mass ratio) between LiMO₂ (space group R-3m) and LiM₂O₄ (space group Fd-3m) may be “LiMO₂/LiM₂O₄=9/1 to 9/1”, “LiMO₂/LiM₂O₄=9/1 to 5/5”, or “LiMO₂/LiM₂O₄=9/1 to 7/3”, for example.

### 5-4-4. Polyanion Compound

The polyanion compound may include a phosphoric acid salt (such as LiFePO₄ for example), a silicic acid salt, a boric acid salt, and/or the like, for example. The polyanion compound may be represented by the following formulae, for example.

LiMPO₄, Li₂₋ₓMPO₄F, Li₂MSiO₄, or LiMBO₃

In the above formulae, M may include, for example, at least one selected from the group consisting of Fe, Mn, and Co. In the above formulae, the relationship of 0≤x≤2 may be satisfied, for example.

The positive electrode active material may include a mixture of LiMO₂ (space group R-3m) and the polyanion compound, for example. The mixing ratio (mass ratio) between LiMO₂ (space group R-3m) and the polyanion compound may be “LiMO₂/(polyanion compound)=9/1 to 9/1”, “LiMO₂/(polyanion compound)=9/1 to 5/5”, or “LiMO₂/(polyanion compound)=9/1 to 7/3”, for example.

### 5-4-5. Dopant

To the positive electrode active material, a dopant may be added. The dopant may be diffused throughout the entire particle, or may be locally distributed. For example, the dopant may be locally distributed on the particle surface. The dopant may be a substituted solid solution atom, or may be an intruding solid solution atom. The amount of the dopant to be added (the molar fraction relative to the total amount of the positive electrode active material) may be from 0.01 to 5%, or may be from 0.1 to 3%, or may be from 0.1 to 1%, for example. A single type of dopant may be added, or two or more types of dopant may be added. The two or more dopants may form a complex.

The dopant may include, for example, at least one selected from the group consisting of B, C, N, a halogen, Si, Na, Mg, Al, Mn, Co, Cr, Sc, Ti, V, Cu, Zn, Ga, Ge, Se, Sr, Y, Zr, Nb, Mo, In, Pb, Bi, Sb, Sn, W, La, Ce, Pr, Nd, Pm, Sm, Eu, Gd, Tb, Dy, Ho, Er, Tm, Yb, Lu, and an actinoid.

For example, to NCA, a combination of “Zr, Mg, W, Sm”, a combination of “Ti, Mn, Nb, Si, Mo”, or a combination of “Er, Mg” may be added.

For example, to NCM, Ti may be added. For example, to NCM, a combination of “Zr, W”, a combination of “Si, W”, or a combination of “Zr, W, Al, Ti, Co” may be added.

### 5-4-6. Surface Covering

Positive electrode 10 may include a composite particle. The composite particle includes a core particle and a covering layer. The core particle includes a positive electrode active material. The covering layer covers at least part of the surface of the core particle. The covering layer may have a thickness from 1 to 3000 nm, or from 5 to 2000 nm, or from 10 to 1000 nm, or from 10 to 100 nm, or from 10 to 50 nm, for example. The thickness of the covering layer may be measured in an SEM image of a cross section of the particle, and/or the like, for example. More specifically, the composite particle is embedded in a resin material to prepare a sample. With the use of an ion milling apparatus, a cross section of the sample is exposed. For example, an ion milling apparatus with the trade name “ArBlade (registered trademark) 5000” manufactured by Hitachi High-Technologies may be used. The cross section of the sample is examined by an SEM. For example, an SEM apparatus with the trade name “SU8030” manufactured by Hitachi High-Technologies may be used. For each of ten composite particles, the thickness of the covering layer is measured in twenty fields of view. The arithmetic mean of a total of 200 thickness measurements is used.

The ratio of the part of the surface of the core particle covered by the covering layer is also called “a covering rate”. The covering rate may be 1% or more, or 10% or more, or 30% or more, or 50% or more, or 70% or more, for example. The covering rate may be 100% or less, or 90% or less, or 80% or less, for example.

For example, the covering rate may be measured by XPS (X-ray Photoelectron Spectroscopy). For example, an XPS apparatus with the trade name “PHI X-tool” manufactured by ULVAC-PHI may be used. A sample powder consisting of the composite particle is loaded in the XPS apparatus. Narrow scan analysis is carried out. The measurement data is processed with an analysis software. For example, an analysis software with the trade name “MulTiPak” manufactured by ULVAC-PHI may be used. The measurement data is analyzed to detect a plurality of types of elements. From the area of each peak, the ratio of the detected element is determined. By the following equation, the covering rate is determined.

$$θ = \{ {I}_{1} / ( {I}_{0} + {I}_{1} ) \} \times 100$$

θ: Covering rate [%]
I₀: Ratio of element attributable to core particle
I₁: Ratio of element attributable to covering layer

For example, when the core particle includes NCM, I₀ represents the total ratio of the elements “Ni, Co, Mn”. For example, when the core particle includes NCA, I₀ represents the total ratio of the elements “Ni, Co, Al”. For example, when the covering layer includes P and B, I₁ represents the total ratio of the elements “P, B”.

The covering layer may include any component. The covering layer may include an elementary substance, organic matter, an inorganic acid salt, an organic acid salt, a hydroxide, an oxide, a carbide, a nitride, a sulfide, a halide, and/or the like, for example. The covering layer may include, for example, at least one selected from the group consisting of B, Al, W, Zr, Ti, Co, F, lithium compound (such as Li₂CO₃, LiHCO₃, LiOH, Li₂O, for example), tungsten oxide (such as WO₃, for example), titanium oxide (such as TiO₂, for example), zirconium oxide (such as ZrO₂, for example), boron oxide, boron phosphate (such as BPO₄, for example), aluminum oxide (such as Al₂O₃, for example), boehmite, aluminum hydroxide, phosphoric acid salt [such as Li₃PO₄, (NH₄)₃PO₄, AlPO₄, for example], boric acid salt (such as Li₂B₄O₇, LiBO₃, for example), polyacrylic acid salt (such as Li salt, Na salt, NH₄ salt), acetic acid salt (such as Li salt, for example), CMC (such as Na salt, Li salt, NH₄ salt), LiNbO₃, Li₂TiO₃, and Li-containing halide (such as LiAlCl₄, LiTiAlF₆, LiYBr₆, LiYCl₆, for example).

### 5-4-7. Hollow Particles, Solid Particles

A hollow particle is a secondary particle. In a cross-sectional image of a hollow particle, the proportion of the area occupied by its central cavity relative to the entire area of the particle is 30% or more. The proportion of the cavity in the hollow particle may be 40% or more, or 50% or more, or 60% or more, for example. A solid particle is a secondary particle. In a cross-sectional image of a solid particle, the proportion of the area occupied by its central cavity relative to the entire area of the particle is less than 30%. The proportion of the cavity in the solid particle may be 20% or less, or 10% or less, or 5% or less, for example. The positive electrode active material may be hollow particles, or may be solid particles. A mixture of hollow particles and solid particles may be used. The mixing ratio (mass ratio) between hollow particles and solid particles may be “(hollow particles)/(solid particles)=1/9 to 9/1”, or “(hollow particles)/(solid particles)=2/8 to 8/2”, or “(hollow particles)/(solid particles)=3/7 to 7/3”, or “(hollow particles)/(solid particles)=4/6 to 6/4”, for example.

### 5-4-8. Large Particles, Small Particles

The positive electrode active material may have a unimodal particle size distribution (based on the number), for example. The positive electrode active material may have a multimodal particle size distribution, for example. The positive electrode active material may have a bimodal particle size distribution, for example. That is, the positive electrode active material may include large particles and small particles. When the particle size distribution is bimodal, the particle size corresponding to the peak top of the larger particle size is regarded as the particle size of the large particles (d_{L}). The particle size corresponding to the peak top of the smaller particle size is regarded as the particle size of the small particles (d_{S}). The particle size ratio (d_{L}/d_{S}) may be from 2 to 10, or from 2 to 5, or from 2 to 4, for example. d_{L} may be from 8 to 20 μm, or from 8 to 15 μm, for example. d_{S} may be from 1 to 10 μm, or from 1 to 5 μm, for example.

For example, with the use of a waveform analysis software, peak separating processing may be carried out for the particle size distribution. The ratio between the peak area of the large particles (S_{L}) and the peak area of the small particles (S_{S}) may be “S_{L}/S_{S}=1/9 to 9/1”, or “S_{L}/S_{S}=5/5 to 9/1”, or “S_{L}/S_{S}=7/3 to 9/1”, for example.

The number-based particle size distribution is measured by a microscope method. From the positive electrode active material layer, a plurality of cross-sectional samples are taken. The cross-sectional sample may include a cross section vertical to the surface of the positive electrode active material layer, for example. By ion milling and/or the like, for example, cleaning is carried out to the side that is to be observed. By SEM, the cross-sectional sample is examined. The magnification for the examination is adjusted in such a way that 10 to 100 particles are contained within the examination field of view. The Feret diameters of all the particles in the image are measured. “Feret diameter” refers to the distance between two points located farthest apart from each other on the outline of the particle. The plurality of the cross-sectional samples are examined to obtain a total of 1000 or more Feret diameters. From the 1000 or more Feret diameters, number-based particle size distribution is created.

The bimodal particle size distribution may be formed by two types of particles mixed together. These two types of particles have different particle size distributions. For example, the two types of particles may have different D50. “D50” refers to a particle size in volume-based particle size distribution at which the cumulative frequency accumulated from the side of small particle sizes reaches 50%. D50 may be measured by laser diffraction. The sample to be measured is powder. For example, the large particles may have a D50 from 8 to 20 μm, or from 8 to 15 μm. For example, the small particles may have a D50 from 1 to 10 μm, or from 1 to 5 μm. The ratio of the D50 of the large particles to the D50 of the small particles may be from 2 to 10, or from 2 to 5, or from 2 to 4, for example. The mixing ratio (mass ratio) between the large particles and the small particles may be “(large particles)/(small particles)=1/9 to 9/1”, or “(large particles)/(small particles)=5/5 to 9/1”, or “(large particles)/(small particles)=7/3 to 9/1”, for example.

The large particles and the small particles may have the same composition, or may have different compositions. For example, the large particles may be NCA and the small particles may be NCM. For example, the large particles may be NCM (0.6≤x) and the small particles may be NCM (x<0.6).

### 6. Electrolyte

In the electrolyte, Li is dissolved. The electrolyte may be a liquid electrolyte, or may be a gelled electrolyte. The liquid electrolyte may include an electrolyte solution, for example. The electrolyte solution includes a solvent and a solute.

### 6-1. Solute

The concentration of the solute may be from 0.5 to 1 mol/L, or from 1 to 1.5 mol/L, or from 1.5 to 2 mol/L, or from 2 to 2.5 mol/L, or from 2.5 to 3 mol/L, for example. The solute includes a supporting salt (a Li salt). The solute may include an inorganic acid salt, an imide salt, an oxalato complex, a halide, and/or the like, for example. The solute may include, for example, at least one selected from the group consisting of LiPF₆, LiBF₄, LiClO₄, LiAsF₆, LiSbF₆, LiN(SO₂F)₂ “LiFSI”, LiN(SO₂CF₃)₂“LiTFSI”, LiB(C₂O₄)₂ “LiBOB”, LiBF₂(C₂O₄) “LiDFOB”, LiPF₂(C₂O₄)₂ “LiDFOP”, LiPO₂F₂, FSO₃Li, LiI, LiBr, and derivatives of these.

### 6-2. Solvent

### 6-2-1. Ether-Based Solvent

The electrolyte solution may include an ether-based solvent. The solvent may include hydrofluoroether (HFE) and/or the like, for example. HFE may include, for example, at least one selected from the group consisting of a difluoromethyl group, a 2,2-difluoroethyl group, a 2,2,2-trifluoroethyl group, a 1,1,2,2-tetrafluoroethyl group, a 2,2,3,3,3-pentafluoropropyl group, a 2,2,3,3-tetrafluoropropyl group, a 1,1,1,3,3,3-hexafluoroisopropyl group, a 1,1,2,3,3,3-hexafluoropropyl group, a 2,2,3,3,4,4,4-heptafluorobutyl group, a 2,2,3,3,4,4-hexafluorobutyl group, and a 2,2,3,3,4,4,5,5-octafluoropentyl group.

HFE may include, for example, at least one selected from the group consisting of 1,1,2,2-tetrafluoroethyl 2,2,3,3-tetrafluoropropyl ether (TTE), 2,2,2-trifluoroethyl ether, difluoromethyl 2,2,3,3-tetrafluoropropyl ether, 2,2,3,3-tetrafluoropropyl 1,1,2,3,3,3-hexafluoropropyl ether, 2,2,3,3,4,4,5,5-octafluoropentyl 1,1,2,2-tetrafluoroethyl ether, and derivatives of these.

The solvent may also include an ether other than HFE (hereinafter also called “a second ether”). The second ether may include, for example, at least one selected from the group consisting of tetrahydrofuran (THF), 1,4-dioxane (DOX), 1,3-dioxolane (DOL), 1,2-dimethoxyethane (DME), 1,2-diethoxyethane (DEE), ethylglyme, triglyme, tetraglyme, and derivatives of these. For example, the solvent may include the second ether (such as DME) in an amount from 1 to 50% in terms of volume fraction, with the remainder being made up of HFE. For example, the solvent may include the second ether in an amount of 10 to 40% in terms of volume fraction, with the remainder being made up of HFE.

### 6-2-2. Carbonate-Based Solvent

The electrolyte solution may include a carbonate-based solvent (a carbonate-ester-based solvent), for example. The solvent may include a cyclic carbonate, a chain carbonate, a fluorinated carbonate, and/or the like, for example. The solvent may include, for example, at least one selected from the group consisting of ethylene carbonate (EC), propylene carbonate (PC), butylene carbonate (BC), dimethyl carbonate (DMC), diethyl carbonate (DEC), ethyl methyl carbonate (EMC), monofluoroethylene carbonate (FEC), difluoroethylene carbonate, 4,4-difluoroethylene carbonate, trifluoroethylene carbonate, perfluoroethylene carbonate, fluoropropylene carbonate, difluoropropylene carbonate, and derivatives of these.

The solvent may include a cyclic carbonate (such as EC, PC, FEC) and a chain carbonate (such as EMC, DMC, DEC). The mixing ratio between the cyclic carbonate and the chain carbonate (volume ratio) may be “(cyclic carbonate)/(chain carbonate)=1/9 to 4/6”, or “(cyclic carbonate)/(chain carbonate)=2/8 to 3/7”, or “(cyclic carbonate)/(chain carbonate)=3/7 to 4/6”, for example.

The solvent may include a cyclic carbonate (such as EC, PC) and a fluorinated cyclic carbonate (such as FEC). The mixing ratio between the cyclic carbonate and the fluorinated cyclic carbonate (volume ratio) may be “(cyclic carbonate)/(fluorinated cyclic carbonate)=99/1 to 90/10”, or “(cyclic carbonate)/(fluorinated cyclic carbonate)=9/1 to 1/9”, or “(cyclic carbonate)/(fluorinated cyclic carbonate)=9/1 to 7/3”, or “(cyclic carbonate)/(fluorinated cyclic carbonate)=3/7 to 1/9”, for example.

The solvent may include EC, FEC, EMC, DMC, and DEC, for example. The volume ratio of these components may satisfy the relationship represented by the following equation, for example.

$${V}_{EC} + {V}_{FEC} + {V}_{EMC} + {V}_{DMC} + {V}_{DEC} = 10$$

In the above equation, each of V_{EC}, V_{FEC}, V_{EMC}, V_{DMC}, and V_{DEC} represents the volume ratio of EC, FEC, EMC, DMC, and DEC, respectively.

The following relationships are satisfied: 1≤V_{EC}≤4, 0≤V_{FEC}≤3, V_{EC}+V_{FEC}≤4, 0≤V_{EMC}≤9, 0≤V_{DMC}≤9, 0≤V_{DEC}≤9, 6≤V_{EMC}+V_{DMC}+V_{DEC}≤9.

In the above equation,

The relationship of 1≤V_{EC}≤2 or 2≤V_{EC}≤3 may be satisfied, for example.

The relationship of 1≤V_{FEC}≤2 or 2≤V_{FEC}≤4 may be satisfied, for example.

The relationship of 3≤V_{EMC}≤4 or 6≤V_{EMC}≤8 may be satisfied, for example.

The relationship of 3≤V_{DMC}≤4 or 6≤V_{DMC}≤8 may be satisfied, for example.

The relationship of 3≤V_{DEC}≤4 or 6≤V_{DEC}≤8 may be satisfied, for example.

The solvent may have a composition of “EC/EMC=3/7”, “EC/DMC=3/7”, “EC/FEC/DEC=1/2/7”, “EC/DMC/EMC=3/4/3”, “EC/DMC/EMC=3/3/4”, “EC/FEC/DMC/EMC=2/1/4/3”, “EC/FEC/DMC/EMC=1/2/4/3”, “EC/FEC/DMC/EMC=2/1/3/4”, “EC/FEC/DMC/EMC=1/2/3/4” (volume ratio), and/or the like, for example.

### 6-3. Additive

The electrolyte solution may include any additive. The amount to be added (the mass fraction to the total amount of the electrolyte solution) may be from 0.01 to 5%, or from 0.05 to 3%, or from 0.1 to 1%, for example. The additive may include a gas generation agent, an overcharging inhibitor, a flame retardant, an antioxidant, an electrode-protecting agent, a surfactant, and/or the like, for example.

The additive may include, for example, at least one selected from the group consisting of vinylene carbonate (VC), vinylethylene carbonate (VEC), 1,3-propane sultone (PS), tert-amylbenzene, 1,4-di-tert-butylbenzene, biphenyl (BP), cyclohexylbenzene (CHB), ethylene sulfite (ES), propane sultone (PS), ethylene sulfate (DTD), γ-butyrolactone, phosphazene compound, carboxylate ester [such as methyl formate (MF), methyl acetate (MA), methyl propionate (MP), diethyl malonate (DEM), for example], fluorobenzene (such as monofluorobenzene (FB), 1,2-difluorobenzene, 1,3-difluorobenzene, 1,4-difluorobenzene, 1,2,3-trifluorobenzene, 1,2,4-trifluorobenzene, 1,3,5-trifluorobenzene, 1,2,3,4-tetrafluorobenzene, 1,2,3,5-tetrafluorobenzene, 1,2,4,5-tetrafluorobenzene, pentafluorobenzene, hexafluorobenzene, for example), fluorotoluene (such as 2-fluorotoluene, 3-fluorotoluene, 4-fluorotoluene, 2,3-difluorotoluene, 2,4-difluorotoluene, 2,5-difluorotoluene, 2,6-difluorotoluene, 3,4-difluorotoluene, octafluorotoluene, for example), benzotrifluoride (such as benzotrifluoride, 2-fluorobenzotrifluoride, 3-fluorobenzotrifluoride, 4-fluorobenzotrifluoride, 2-methylbenzotrifluoride, 3-methylbenzotrifluoride, 4-methylbenzotrifluoride, for example), fluoroxylene (such as 3-fluoro-o-xylene, 4-fluoro-o-xylene, 2-fluoro-m-xylene, 5-fluoro-m-xylene, for example), sulfur-containing heterocyclic compound (such as benzothiazole, 2-methylbenzothiazole, tetrathiafulvalene, for example), nitrile compound (such as adiponitrile, succinonitrile, for example), phosphate (such as trimethyl phosphate, triethyl phosphate, for example), carboxylic anhydride (such as acetic anhydride, propionic anhydride, oxalic anhydride, succinic anhydride, maleic anhydride, phthalic anhydride, benzoic anhydride, for example), alcohol (such as methanol, ethanol, n-propyl alcohol, ethylene glycol, diethylene glycol monomethyl ether, for example), and derivatives of these.

The components described above as the solute and the solvent may be used as a trace component (an additive). The additive may include, for example, at least one selected from the group consisting of LiBF₄, LiFSI, LiTFSI, LiBOB, LiDFOB, LiDFOP, LiPO₂F₂, FSO₃Li, LiI, LiBr, HFE, DOX, PC, FEC, and derivatives of these.

### 6-4. Ionic Liquid

The liquid electrolyte may include an ionic liquid. The liquid electrolyte may include, for example, at least one selected from the group consisting of a sulfonium salt, an ammonium salt, a pyridinium salt, a piperidinium salt, a pyrrolidinium salt, a morpholinium salt, a phosphonium salt, an imidazolium salt, and derivatives of these.

### 6-5. Gelled Electrolyte

The gelled electrolyte may include a liquid electrolyte and a polymer material. The polymer material may form a polymer matrix. The polymer material may include, for example, at least one selected from the group consisting of PVdF, PVdF-HFP, PAN, PVdF-PAN, PEO, PEG, and derivatives of these.

### 7. Separator

Separator 30 is capable of separating positive electrode 10 from negative electrode 20. Separator 30 is electrically insulating. Separator 30 may include, for example, at least one selected from the group consisting of a resin film, an inorganic particle layer, and an organic particle layer. Separator 30 may include a resin film and an inorganic particle layer, for example.

### 7-1. Resin Film

The resin film is porous. The resin film may include a microporous film, a nonwoven fabric, and/or the like, for example. The resin film includes a resin skeleton. The resin skeleton may be contiguous in mesh form, for example. Gaps in the resin skeleton form pores. The resin film allows the electrolyte to permeate therethrough. The resin film may have an average pore size of 1 μm or less, for example. The resin film may have an average pore size from 0.01 to 1 μm, or from 0.1 to 0.5 μm, for example. “Average pore size” may be measured by mercury porosimetry. The resin film may have a Gurley value from 50 to 250 s/100 cm³, for example. “Gurley value” may be measured by a Gurley test method.

The resin film may include, for example, at least one selected from the group consisting of an olefin-based resin, a polyurethane-based resin, a polyamide-based resin, a cellulose-based resin, a polyether-based resin, an acrylic-based resin, a polyester-based resin, and the like. The resin film may include, for example, at least one selected from the group consisting of PE, PP, PA, PAI, PI, aromatic polyamide (aramid), and polyphenylene ether (PPE), and derivatives of these. The resin film may be formed by stretching, phase separation, and/or the like, for example. The resin film may have a thickness from 5 to 50 μm, or from 10 to 25 μm, for example.

The resin film may have a monolayer structure. The resin film may consist of a PE layer, for example. A skeleton of a PE layer is formed of PE. The PE layer may have shut-down function. The resin film may have a multilayer structure, for example. The resin film may include a PP layer and a PE layer, for example. A skeleton of a PP layer is formed of PP. The resin film may have a three-layer structure, for example. The resin film may be formed by stacking a PP layer, a PE layer, and a PP layer in this order, for example. The thickness of the PE layer may be from 5 to 20 μm, for example. The thickness of the PP layer may be from 3 to 10 μm, for example.

### 7-2. Inorganic Particle Layer

The inorganic particle layer may be formed on the surface of the resin film. The inorganic particle layer may be formed on only one side of the resin film, or may be formed on both sides of the resin film. The inorganic particle layer may be formed on the side facing positive electrode 10, or may be formed on the side facing negative electrode 20. The inorganic particle layer may be formed on the surface of positive electrode 10.

The inorganic particle layer is porous. The inorganic particle layer includes inorganic particles. The inorganic particles may also be called “an inorganic filler”. Gaps between the inorganic particles form pores. The inorganic particle layer may have a thickness from 0.5 to 10 μm, or from 1 to 5 μm, for example. The inorganic particles may include a heat-resistant material, for example. The inorganic particle layer that includes a heat-resistant material is also called “HRL (Heat Resistance Layer)”. The inorganic particles may include at least one selected from the group consisting of boehmite, alumina, zirconia, titania, magnesia, silica, and the like. The inorganic particles may have any shape. The inorganic particles may be spherical, rod-like, plate-like, fibrous, and/or the like, for example. The inorganic particles may have a D50 from 0.1 to 10 μm, or from 0.5 to 3 μm, for example. The inorganic particle layer may further include a binder. The binder may include, for example, at least one selected from the group consisting of an acrylic-based resin, a polyamide-based resin, a fluorine-based resin, an aromatic-polyether-based resin, and a liquid-crystal-polyester-based resin, and the like.

### 7-3. Organic Particle Layer

Separator 30 may include an organic particle layer, for example. Separator 30 may include an organic particle layer instead of the resin film, for example. Separator 30 may include an organic particle layer instead of the inorganic particle layer, for example. Separator 30 may include both the resin film and an organic particle layer. Separator 30 may include both the inorganic particle layer and an organic particle layer. Separator 30 may include all of the resin film, the inorganic particle layer, and an organic particle layer.

The organic particle layer may have a thickness from 0.1 to 50 μm, or from 0.5 to 20 μm, or from 0.5 to 10 μm, or from 1 to 5 μm, for example. The organic particle layer includes organic particles. The organic particles may also be called “an organic filler”. The organic particles may include a heat-resistant material. The organic particles may include, for example, at least one selected from the group consisting of PE, PP, PTFE, PI, PAI, PA, aramid, and the like. The organic particles may be spherical, rod-like, plate-like, fibrous, and/or the like, for example. The organic particles may have a D50 from 0.1 to 10 μm, or from 0.5 to 3 μm, for example.

Separator 30 may include a mixed layer, for example. The mixed layer includes both inorganic particles and organic particles.

What is claimed is:

1. A lithium metal secondary battery comprising:
a power generation element; and
an electrolyte, wherein
the power generation element includes a positive electrode and a negative electrode,
the negative electrode includes a base material and raised portions,
the base material is electrically conductive,
the raised portions are electrically insulating,
depressed portions are formed on a surface of the base material,
the raised portions are provided on the surface of the base material,
the raised portions protrude outwardly from the surface of the base material, and
a relationship of the following expression is satisfied:
0.001≤d/h≤10
where
d represents a depth of the depressed portions,
h represents a height of the raised portions, and
the depth and the height are relative to the surface of the base material.

2. The lithium metal secondary battery according to claim 1, wherein the base material is porous.

3. The lithium metal secondary battery according to claim 1, wherein
a seed material is placed inside the depressed portions, and
the seed material includes at least one selected from the group consisting of Li, Mg, Al, Zn, Ag, Pt, and Au.

4. The lithium metal secondary battery according to claim 1, wherein at least one selected from the group consisting of a solid electrolyte and a gelled electrolyte is placed inside the depressed portions.

5. The lithium metal secondary battery according to claim 1, wherein the raised portions extend linearly when viewed in a plane.

6. The lithium metal secondary battery according to claim 1, wherein the raised portions are distributed in a dot pattern when viewed in a plane.

7. The lithium metal secondary battery according to claim 1, wherein the raised portion has a tapered shape or an inverted tapered shape when viewed in a cross section.

8. The lithium metal secondary battery according to claim 7, wherein
the power generation element is a wound electrode assembly,
the base material has an inner circumferential surface and an outer circumferential surface,
the inner circumferential surface is positioned on an inner circumferential side of the wound electrode assembly,
the outer circumferential surface is a surface opposite to the inner circumferential surface,
the raised portions are provided on each of the inner circumferential surface and the outer circumferential surface,
the raised portion on the inner circumferential surface has a tapered shape, and
the raised portion on the outer circumferential surface has an inverted tapered shape.

9. The lithium metal secondary battery according to claim 7, wherein
the power generation element is a wound electrode assembly,
the base material has an inner circumferential surface and an outer circumferential surface,
the inner circumferential surface is positioned on an inner circumferential side of the wound electrode assembly,
the outer circumferential surface is a surface opposite to the inner circumferential surface,
the raised portions are provided on each of the inner circumferential surface and the outer circumferential surface,
the raised portion on the inner circumferential surface has an inverted tapered shape, and
the raised portion on the outer circumferential surface has a tapered shape.
